(19) United States
(12) Patent Application Publication
(10) Pub. No.: US 2016/0190857 A1
(43) Pub. Date: Jun. 30, 2016

(54) APPARATUS, SYSTEMS AND METHODS FOR CHARGING A TABLET DEVICE

(71) Applicant: David Stewart SLATER, Vancouver (CA)

(72) Inventor: David Stewart SLATER, Vancouver (CA)

(21) Appl. No.: 14/905,806

(22) PCT Filed: Jul. 17, 2014
(86) PCT No.: PCT/IB2014/063168

§ 371 Date: Jan. 17, 2016

Related U.S. Application Data
(60) Provisional application No. 61/847,283, filed on Jul. 17, 2013.

(51) Int. Cl. H02J 7/02; H02J 7/04

(52) U.S. Cl. CPC H02J 7/025; H02J 7/045; H02J 2007/0096

(57) ABSTRACT

A tablet device charging mount apparatus is described, with related systems and methods, which allows for wireless charging of a tablet device mounted on a camera, and where it is contemplated that the tablet is operated in conjunction with the use and control of the camera. The mount comprises a wireless power transmitter which wirelessly charges a battery in the tablet device. It is contemplated that the wireless power transmitter may be electrically connected to an external power source which may be a dedicated battery, an external camera battery, and a camera internal battery. It is further contemplated that the power source may be integral to the mount apparatus. The wireless power transmitter may comprise a controller to automatically regulate the power requirements of the tablet. The charging mount apparatus allows the tablet battery runtime to match and potentially exceed that of the camera battery runtime without disconnecting the tablet from the camera.

### PRIORITY CLAIM

The present application claims the priority of U.S. Provisional Application No. 61/847283 filed on Jul. 17, 2013, wherein the U.S. priority application is herein incorporated by reference.

### TECHNICAL FIELD

This invention relates to apparatus, systems and methods for charging a tablet device.

### BACKGROUND

Tablet computers are portable one-piece computers with a touchscreen display screen. Tablet computers are typically used for viewing videos and documents, emailing, social networking, internet browsing, and the like.

A recent development in digital photography has been the use of tablet computers to control digital cameras, in particular to control digital single lens reflexive (DSLR) cameras. This approach allows the camera's field of view to be viewed in real time on the typically larger and higher resolution screen of the tablet computer. Users can also use the tablet device to remotely control the camera's functions and to view, edit, and otherwise manage images in the field without having to first return to a workstation or home computer. DSLR Controller™ is an example of enabling software.

It is usually not practical for a user to simultaneously hold a camera and operate a tablet computer to capture an image unless at least one of the two devices is independently supported, for example by a tripod in the case of the camera. Even if a hands-free support for the camera is available, it would be convenient for the user to be able to free up the hand(s) that would otherwise be needed to hold the tablet computer. Mounts for supporting a tablet device using a camera are described by the present inventor in U.S. provisional application No. 61/807,917 and 61/847,248, and PCT application no. PCT/IB2014/060348, incorporated by reference herein.

Tablet computers and other tablet devices are designed for portability, which sets size and therefore battery life constraints on tablet batteries. Current tablet computer batteries typically require recharging after several hours of use. Novel and convenient apparatus, systems and methods for charging the battery of a tablet device are desirable.

### SUMMARY OF THE INVENTION

In the present invention apparatus, systems and methods are provided which allows for the charging of a battery of a tablet device mounted on a camera. Some embodiments relate to a mount apparatus for mounting a tablet device on a camera wherein the mount is configured to utilize power from the camera's battery to recharge the tablet device's battery. Further embodiments relate to a mount which is configured to utilize power from a dedicated external battery, or a battery integral with the mount, to recharge the tablet device's battery. Systems may comprise a tablet device attached to a camera by the use of an apparatus mount comprising a wireless power transmitter that charges the battery of a tablet device. Methods may comprise attaching a tablet device to a camera via an apparatus mount and establishing a wireless connection link between the tablet device and the wireless power transmitter.

In preferred embodiments the mount apparatus comprises a wireless power transmitter and wirelessly transmits power to the tablet battery.

In further preferred embodiments the wireless power transmitter may comprise a controller to regulate power to the tablet device, and it is further contemplated that the controller may automatically regulate power to the tablet device based on predetermined charge threshold levels and criteria.

### BRIEF DESCRIPTION OF DRAWINGS

In drawings which show non-limiting embodiments of the invention:

FIG. 1 is a perspective view of a tablet device mounted on a camera according to an embodiment of the invention;

FIG. 2A to 2C are top views of camera hot shoes;

FIG. 3 is a front view of a tablet device mount for a camera according to an embodiment of the invention;

FIG. 4 is a side view of the mount shown in FIG. 3; and

FIG. 5 is a side view of a tablet device mount for a camera according to another embodiment of the invention.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The invention relates to apparatus, systems and methods for charging a battery of a tablet device being used with a camera. Some embodiments relate to a mount for mounting a tablet device on a camera wherein the mount is configured to utilize power from the camera's battery to recharge the tablet device's battery. The mount comprises a base, an arm, and head. The head comprises a wireless power transmitter and is detachably coupleable to the tablet device (or a holder of the tablet device). The base comprises base contacts and is detachably coupleable to a hot shoe of the camera. The wireless power transmitter is in electrical connection with the base contacts. The base contacts are in electrical connection with corresponding contacts of the hot shoe when the base is coupled to the hot shoe. The camera is configured to supply power from the camera battery to the hot shoe contacts. Power is transmitted from the camera battery to the hot shoe contacts to the base contacts to the wireless power transmitter, which in turn wirelessly transmits power to the tablet battery when the head is coupled to the tablet device. Related systems and methods are also described.

The term “tablet device” as used in this specification refers to tablet computers, phablets, smartphones, and other standalone portable electronic devices with touchscreen/button control display screens. The term “tablet device” does not refer to computer monitors, field monitors, or television monitors. The term “camera” as used in this specification refers to digital single lens reflexive (DSLR) cameras, mirrorless interchangeable lens cameras (MILCs), and other similar devices with optical systems for detecting and recording digital still images and video.

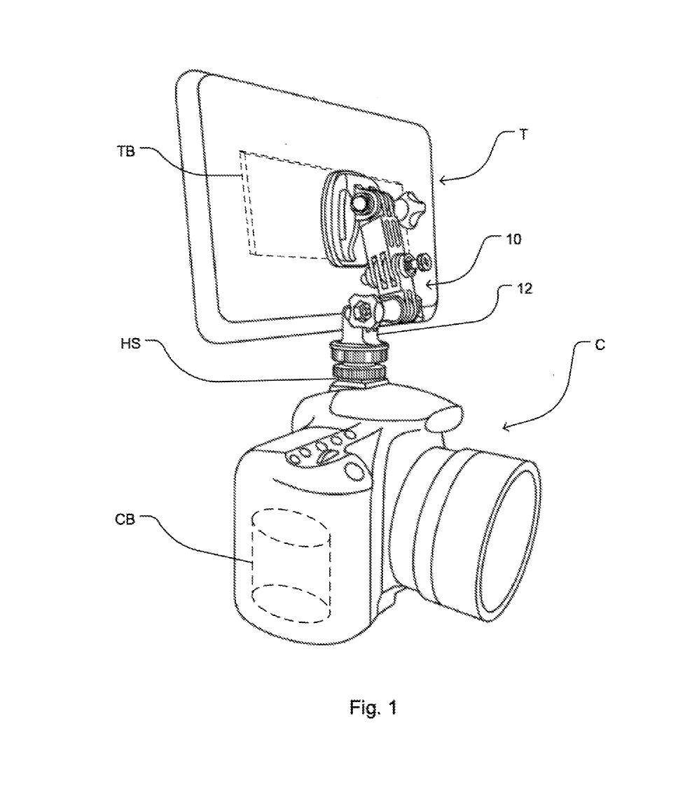

FIGS. 1, 3 and 4 show a mount 10 according to an embodiment of the invention. In some embodiments, mount 10 may be a mount as described in U.S. provisional applications No. 61/807,917 and 61/847248, and PCT application no. PCT/IB2014/060348. Mount 10 mounts tablet device T on a camera C at hot shoe HS. Camera C is powered by one or more camera batteries CB. Tablet device T is powered by one or more tablet batteries TB and is attached to mount 10 by tablet holder TH.

Mount 10 includes a base 12. Base 12 includes base contacts 14. In some embodiments, a positive/negative pair of base contacts 14 are configured to be in electrical connection with a corresponding positive/negative pair of hot shoe contacts HC of hot shoe HS when base 12 is coupled to hot shoe HS. Hot shoe contacts HC are configured to supply power from camera battery CB.

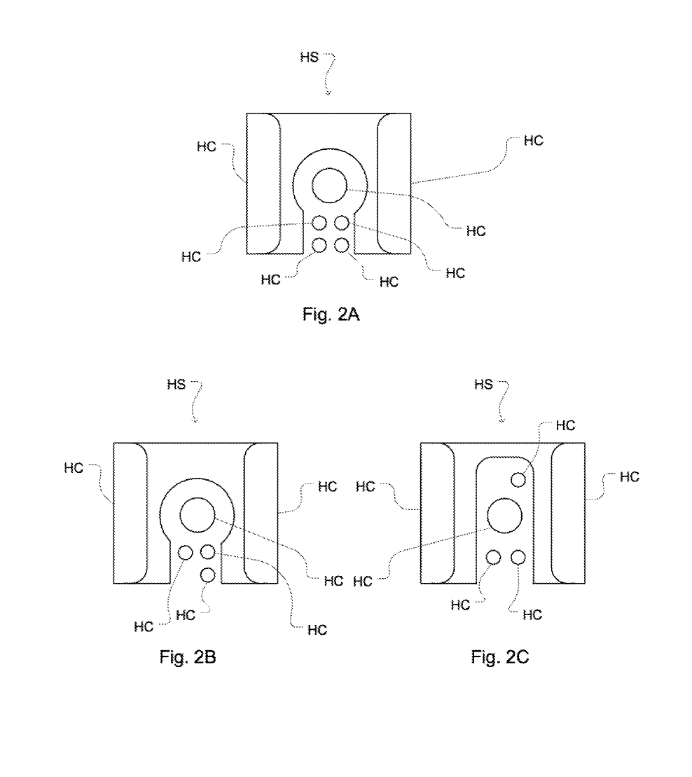

FIGS. 2A to 2C illustrate exemplary hot shoes HS of various brands of cameras and the arrangement of pre-existing hot shoe contacts HC. In some embodiments, any one hot shoe contact of a hot shoe HS may be a positive contact in electrical connection with the positive terminal of camera battery CB, and any other hot shoe contact HC of the hot shoe HS may be a negative contact in electrical connection with the negative terminal of camera battery CB. In some embodiments camera C may hold more than one camera battery CB, in which case hot shoe contacts HC may be in electrical connection with one or more camera batteries CB. In other embodiments, hot shoe HS of camera C may be modified to provide dedicated contacts (not shown) for electrical connection with base contacts 14.

In some embodiments base 12 includes a voltage converter 16 to convert voltage from camera battery CB to a voltage suitable for charging tablet battery TB. In other embodiments voltage converter 16 may be absent, or located in or on a different part of mount 10, or in camera C.

Mount 10 also includes a lower arm 18 coupled to base 12. Base 12 is pivotally coupled to lower arm 18 at lower pivot joint 20. Mount 10 also includes an upper arm 22 coupled to lower arm 18. Upper arm 22 is pivotally coupled to lower arm 18 at middle pivot joint 30. Upper arm 22 includes a lower segment 26 and an upper segment 28 pivotally coupled at a level joint 24. Mount 10 also includes a head 32 coupled to upper arm 28. One end of head 32 is pivotally coupled to upper arm 28 at upper pivot joint 40. The other end of head 32 comprises a tablet holder TH which directly or indirectly couples to tablet device T.

Wireless power transmitter 50 is mounted to tablet holder TH, or is integral with tablet holder TH. In other embodiments wireless power transmitter 50 may be mounted to or integral with a different part of mount 10 provided tablet battery TB remains within range of wireless power transmitter 50 when tablet device T is coupled to tablet holder TH. Wireless power transmitter 50 may utilize any suitable wireless power transmission technology such as inductive power transfer technology (e.g. the QI™ system). Wireless power transmitter 50 provides power levels suitable for charging tablet battery TB. In some embodiments the power level may range from 2.5 to 10 W.

Wireless power transmitter 50 includes a controller 52. Controller 52 regulates power transmission from wireless power transmitter 50 to tablet battery TB. Controller 52 may communicate with tablet device T and be configured to stop supplying power to tablet battery TB once tablet battery TB is fully charged or reaches some predetermined charge threshold. In some embodiments, controller 52 may allow continuous or intermittent transmission of power from wireless power transmitter 50 to tablet battery TB. In some embodiments, controller 52 may communicate with camera C and provide for transmission of power to tablet battery TB only when the charge level of camera battery CB is above a predetermined threshold level. In some embodiments, controller 52 may communicate with tablet device T and provide transmission of power to tablet battery TB only when the charge level of tablet battery TB falls below a predetermined threshold level. In some embodiments, controller 52 may be manually operated by a user through a physical switch on mount 10, through tablet device T, and/or through camera C. In some embodiments controller 52 may be integral with wireless power transmitter 50 as shown in the illustrated embodiment. In other embodiments, controller 52 may be mounted to or integral with a different part of mount 10.

In some embodiments, a wireless communication transmitter that allows tablet device T to control camera C, previously a component of camera C, is alternatively or additionally incorporated into mount 10. The wireless communication transmitter is in wireless signal communication (e.g. Bluetooth, WiFi) with tablet device T. The wireless communication transmitter is also in signal communication with contacts at the bottom of base 12, which in turn are in signal communication with corresponding contacts at hot shoe HS when mount 10 is coupled to camera C. The wireless communication transmitter may for example be located at tablet head TH along with wireless power transmitter 50, or any other suitable location on or in mount 10.

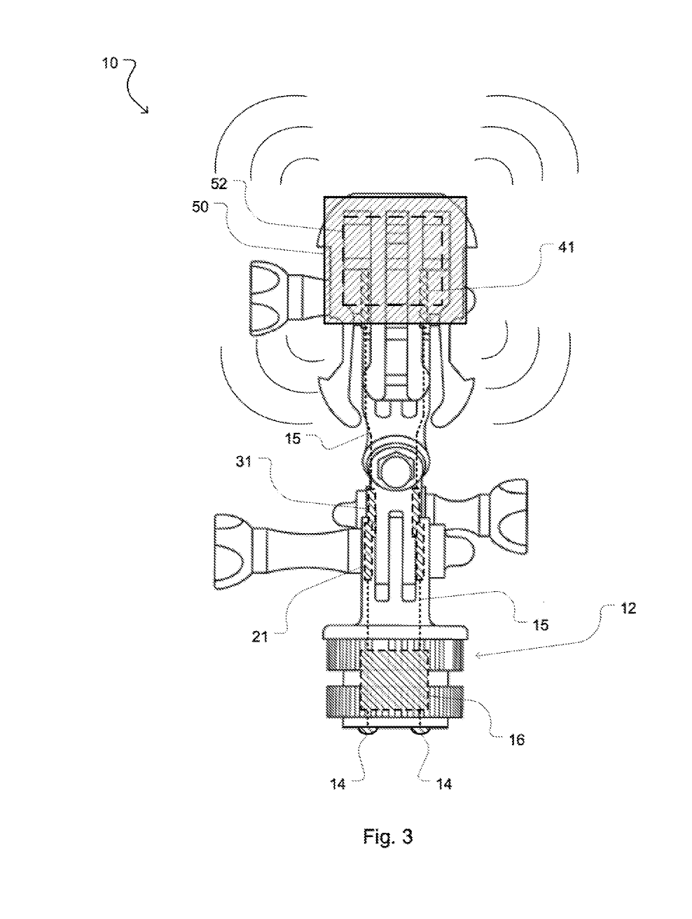

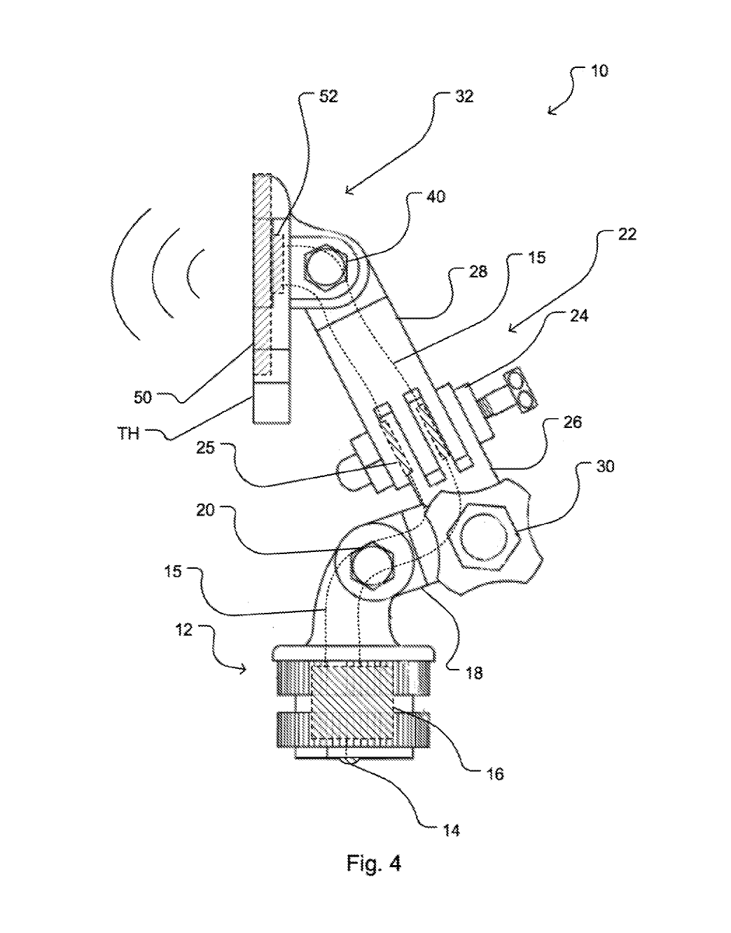

Electrical connection 15 provides electrical connection between base contacts 14 and wireless power transmitter 50. Positive and negative electrical connections 15 are separated by non-conductive material, such as plastic core material of the arms of mount 10. In embodiments such as that illustrated in the Figures where the mount includes one or more jointed arms, electrical connection 15 includes suitable conducting points at the joints. For example, as shown in FIGS. 3 and 4, each of lower pivot joint 20, middle pivot joint 30, upper pivot joint 40 and level joint 24 are provided with respective conducting plates 21, 31, 41 and 25 for maintaining a continuous electrical connection through each moveable joint.

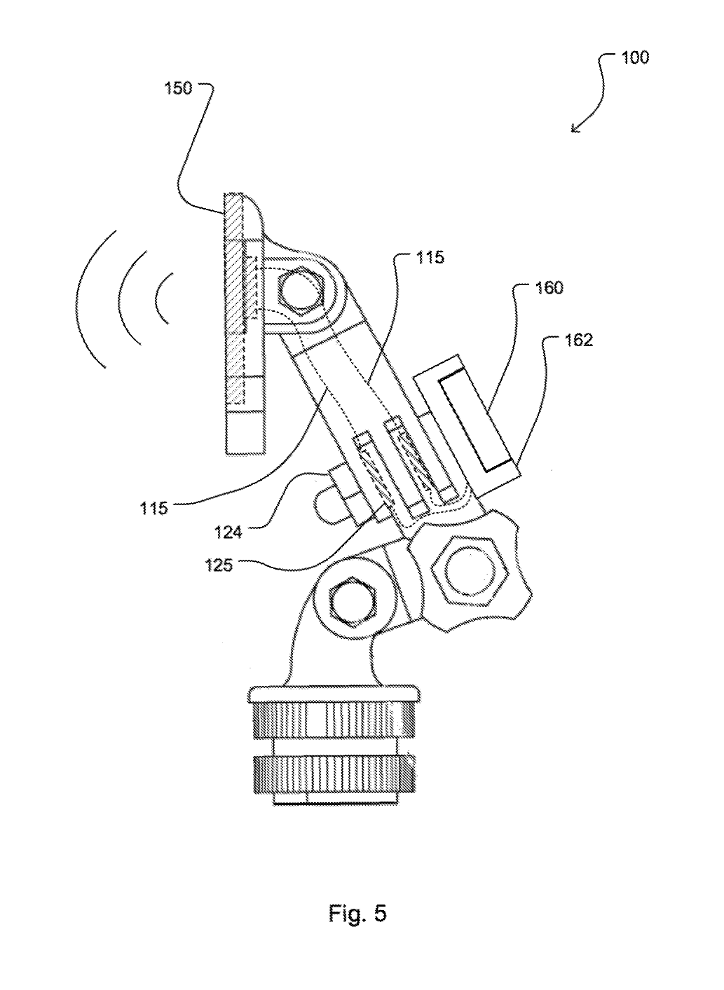

FIG. 5 shows a mount 100 according to an alternative embodiment of the invention. Mount 100 has similar features with similar functions to mount 10 except that instead of camera battery CB inside camera C, wireless power transmitter 150 draws power from a battery 160 in a battery holder 162 attached to an arm of mount 100. In some embodiments, battery 160 may be a camera battery CB or an alternative dedicated battery. Electrical connection 115 provides electrical connection between wireless power transmitter 150 and battery holder 162. In alternative embodiments, battery 160 and battery holder 162 may be substituted with a rechargeable battery (not shown) integral with mount 100. Electrical connection 115 includes conducting points at joints of mount 100, such as conducting plate 125 at level joint 124, to maintain a continuous electrical connection through the moveable joints.

In operation, a user would mount tablet device T on a camera C using a mount such as mount 10. Tablet battery TB will typically have a shorter battery life than camera battery CB and therefore will require recharging sooner. Recharging tablet battery TB by plugging tablet device T directly into a wall outlet or docking it in a recharging dock may not be possible or may be inconvenient. In such situations, a user may rely on camera battery CB to recharge tablet battery TB through mount 10. Controller 52 of wireless power transmitter 50 may be activated manually by the user or automatically by controller 52 receiving a signal from tablet device T that the battery life of tablet battery TB has fallen below a predetermined threshold, such as below 25%, below 10%, or below 5%. Controller 52 may also stop recharging tablet battery TB once tablet battery TB is fully charged or reaches some predetermined charge threshold, or if the battery life of camera battery CB falls below a predetermined charge threshold, such as below 25%, below 10%, or below 5%.

Where a component (e.g. contact, conducting plate, electrical connection, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. For example mount 10 as described and illustrated herein is merely illustrative. The mount may be any mount capable of mounting a tablet device to a camera and comprising at least a tablet head for detachable coupling to the tablet device (or a tablet device holder), a base for detachable coupling with a hot shoe of a camera, and an arm (articulating or non-articulating) extending between the head and the base, wherein the tablet head comprises a wireless power transmitter and the base comprises base contacts, wherein the wireless power transmitter is in electrical connection with the base contacts. Similarly, mount 100 as described and illustrated herein is merely illustrative. The mount may be any mount capable of mounting a tablet device to a camera and comprising at least a tablet head for detachable coupling to the tablet device (or a tablet device holder), a base for detachable coupling with a hot shoe of a camera, and an arm (articulating or non-articulating) extending between the head and the base, wherein the tablet head comprises a wireless power transmitter, and wherein the wireless power transmitter is in electrical connection with a battery mounted on or integral with the mount.

What is claimed:

1. An apparatus for wirelessly charging a tablet device mounted on a camera, the apparatus comprising:
a tablet head detachably coupleable to a tablet device;
a base detachably coupleable to a hot shoe of a camera;
an arm extending between the tablet head and the base,
wherein the tablet head comprises a wireless power transmitter connected to a controller unit,
wherein the controller unit controls a wireless connection link between the wireless power transmitter and the tablet device, and the wireless power transmitter transmits wireless power so as to perform wireless charging of a tablet battery contained in the tablet device,
and wherein the tablet head further comprises a tablet device holder for attaching to the tablet device.

2. (canceled)

3. The apparatus of claim 1, wherein the apparatus comprises an external battery removably attached to the apparatus, wherein the external battery is in electrical connection to the wireless power transmitter.

4. The apparatus of claim 1, wherein the apparatus comprises a camera battery holder attached to the apparatus, wherein the camera battery holder is in electrical connection to the wireless power transmitter.

5. The apparatus of claim 1, wherein a rechargeable power source is integral with the apparatus, and wherein the rechargeable power source is in electrical connection to the wireless power transmitter.

6. The apparatus of claim 1, wherein the base comprises a contact terminal which is in electrical contact with a contact terminal on the hot shoe of the camera, and wherein the wireless power transmitter is in electrical connection with the contact terminal on the base.

7. The apparatus of claim 6, wherein a camera battery contained in the camera is in electrical connection with the wireless power transmitter via the contact terminal of the hot shoe, wherein the wireless power transmitter charges the tablet device using power from the camera battery.

8. The apparatus of claim 1, comprising a voltage convertor integral to the apparatus, wherein the voltage converter is in electrical connection to the wireless power transmitter.

9. The apparatus of claim 8, further comprising an external battery removable attached to the apparatus, wherein the external battery is in electrical connection to voltage converter.

10. The apparatus of claim 8, further comprising a battery holder attached to the apparatus, wherein the battery holder is in electrical connection to the voltage converter.

11. The apparatus of claim 8, wherein the voltage convertor is in electrical connection with a battery contained in the camera.

12. The apparatus of claim 1, wherein the controller unit wirelessly communicates with the tablet device and regulates power to the tablet device.

13. The apparatus of claim 12, wherein the controller unit automatically regulates power to the tablet device based on an at least one predetermined charge threshold level.

14. An apparatus according to any one of claims 3 to 13, wherein the wireless power transmitter uses power from a source external to the wireless power transmitter to wirelessly charge the tablet battery contained in the tablet device.

15. A system comprising:
the tablet device;
the camera comprising the hot shoe;
and an apparatus according to any one of claims 1 to 13 wherein the wireless power transmitter wirelessly charges the tablet battery contained in the tablet device.

16. A method of wirelessly charging a tablet device mounted on a camera, the method comprising the steps of:
(a) providing an apparatus according to any one of claims 1 to 13;
(b) attaching the base of the apparatus to the hot shoe of the camera;
(c) attaching the tablet head to the tablet device;
(d) using the controller unit to establish a wireless connection link between the tablet device and the wireless power transmitter, wherein the wireless power transmitter wirelessly charges the tablet battery contained in the tablet device.

17. The method according to claim 16, wherein step (d) further comprises using the controller unit to automatically regulate power from the wireless power transmitter to the tablet device.

18. The method according to claim 16, wherein step (d) further comprises using a physical switch located on the apparatus to manually establish the wireless connection link and activate the wireless charging.

19. The method according to claim 16, wherein step (d) further comprises using a physical switch located on the apparatus to manually operate the controller unit, wherein the controller unit automatically regulates power from the wireless power transmitter to the tablet device.

20. The apparatus of claim 3, wherein the wireless power transmitter and the external battery are combined into a single unit, and wherein the single unit is removably attached to the tablet head.

21. An apparatus according to claim 1, wherein the base utilizes a screw-thread mechanism for detachable coupling.

22. The apparatus of claim 21, wherein in the screw-thread mechanism is a ¼ inch thread size, or wherein the screw-thread mechanism is a ⅜ inch thread size.

23. An apparatus according to any of claims 3 to 5, claims 8 to 14, and claim 20, wherein the base of the apparatus utilizes a screw-thread mechanism for detachable coupling.

24. The apparatus of claim 23, wherein in the screw-thread mechanism is a ¼ inch thread size, or wherein the screw-thread mechanism is a ⅜ inch thread size.

25. A system comprising:
the tablet device;
the camera comprising the hot shoe;
and an apparatus according to any one of claims 1 to 13 wherein the wireless power transmitter wirelessly charges the tablet battery contained in the tablet device, and wherein the base utilizes a screw-thread mechanism for detachable coupling to the hot shoe of the camera.
